(19) United States
(12) Patent Application Publication
(10) Pub. No.: US 2023/0093314 A1
(43) Pub. Date: Mar. 23, 2023

(54) PASSIVE FLOW REVERSAL REDUCTION IN COMPRESSOR ASSEMBLY

(71) Applicant: Carrier Corporation, Palm Beach Gardens, FL (US)

(72) Inventors: Vishnu M. Sishtla, Syracuse, NY (US); Chaitanya Halbe, Hamden, CT (US)

(21) Appl. No.: 17/939,540

(22) Filed: Sep. 7, 2022

Related U.S. Application Data
(60) Provisional application No. 63/245,542, filed on Sep. 17, 2021.

(51) Int. Cl. F04D 29/44; F04D 29/42; F04D 17/10; F04D 29/66

(52) U.S. Cl. CPC F04D 29/441; F04D 29/4206; F04D 17/10; F04D 29/661

(57) ABSTRACT

A compressor includes a housing having an inlet and an outlet and a fluid flow path extending between the inlet and the outlet. An impeller is mounted within the housing and is movable to move a fluid from the inlet along the fluid flow path to the outlet. A plurality of flow interference elements is arranged within the housing at one or more locations along the fluid flow path. When a fluid flows through the fluid flow path in a backwards direction of flow, a disturbance is generated in the fluid adjacent each of the plurality of flow interference elements.

### CROSS-REFERENCE TO RELATED APPLICATIONS

This application claims the benefit of U.S. Provisional Application No. 63/245,542 filed Sep. 17, 2021, the disclosure of which is incorporated herein by reference in its entirety.

### BACKGROUND

Exemplary embodiments disclosed herein relate generally to a refrigeration system, and more particularly, to an improvement for reducing the potential for flow reversal during a compressor surge or sudden shut down event.

Large chiller refrigeration systems commonly use centrifugal compressors. Under certain conditions, such as a sudden shutdown or surge event, the refrigerant vapor may flow backward from the condenser into the compressor. This flow reversal can induce large dynamic forces on the movable components of the compressor, such as the rotor and bearings, leading to increased noise, vibration, and the potential for damage.

### BRIEF DESCRIPTION

According to an embodiment, a compressor includes a housing having an inlet and an outlet and a fluid flow path extending between the inlet and the outlet. An impeller is mounted within the housing and is movable to move a fluid from the inlet along the fluid flow path to the outlet. A plurality of flow interference elements is arranged within the housing at one or more locations along the fluid flow path. When a fluid flows through the fluid flow path in a backwards direction of flow, a disturbance is generated in the fluid adjacent each of the plurality of flow interference elements.

In addition to one or more of the features described above, or as an alternative, in further embodiments the plurality of flow interference elements arranged within the housing at the one or more locations along the fluid flow path are substantially identical.

In addition to one or more of the features described above, or as an alternative, in further embodiments the plurality of flow interference elements arranged within the housing at the one or more locations along the fluid flow path are spaced in a direction parallel to a direction of flow of the fluid flow path.

In addition to one or more of the features described above, or as an alternative, in further embodiments the plurality of flow interference elements arranged within the housing at the one or more locations along the fluid flow path are spaced in a direction away from a direction of flow of the fluid flow path.

In addition to one or more of the features described above, or as an alternative, in further embodiments at least one of the plurality of flow interference elements extends at an angle relative to the fluid flow path.

In addition to one or more of the features described above, or as an alternative, in further embodiments a distal end of each of the plurality of flow interference elements is arranged at a non-zero angle relative to the fluid moving in the backwards direction of flow through the fluid flow path.

In addition to one or more of the features described above, or as an alternative, in further embodiments comprising a diffuser section within the housing downstream from the impeller along the fluid flow path, wherein a portion of the plurality of flow interference elements are located at the diffuser section.

In addition to one or more of the features described above, or as an alternative, in further embodiments the diffuser section includes a diffuser structure and the portion of the plurality of flow interference elements are formed in the diffuser structure.

In addition to one or more of the features described above, or as an alternative, in further embodiments the diffuser section includes a silencer and the portion of the plurality of flow interference elements are formed in the silencer.

In addition to one or more of the features described above, or as an alternative, in further embodiments comprising a volute formed within the housing downstream from the impeller along the fluid flow path, wherein a portion of the plurality of flow interference elements are located within the volute.

In addition to one or more of the features described above, or as an alternative, in further embodiments the portion of the plurality of flow interference elements located within the volute are integrally formed with the housing.

In addition to one or more of the features described above, or as an alternative, in further embodiments comprising a plate positioned within the volute, wherein the portion of the plurality of flow interference elements located within the volute are formed in the plate.

In addition to one or more of the features described above, or as an alternative, in further embodiments a portion of the plurality of flow interference elements are integrally formed with the housing.

In addition to one or more of the features described above, or as an alternative, in further embodiments the one or more locations includes a plurality of distinct locations.

In addition to one or more of the features described above, or as an alternative, in further embodiments a configuration of the plurality of flow interference elements varies between each of the plurality of distinct locations.

In addition to one or more of the features described above, or as an alternative, in further embodiments the compressor is part of a refrigeration system.

### BRIEF DESCRIPTION OF THE DRAWINGS

The following descriptions should not be considered limiting in any way. With reference to the accompanying drawings, like elements are numbered alike:

FIG. 1 is a cross-sectional view of an exemplary centrifugal compressor according to an embodiment;

FIG. 2 is a detailed cross-sectional view of an exemplary centrifugal compressor according to an embodiment;

FIG. 3 is a perspective view of a diffuser structure of a centrifugal compressor according to an embodiment;

FIG. 4 is a front view of a silencer of a centrifugal compressor according to an embodiment;

FIG. 5A is a schematic diagram of a plurality of flow interference elements arranged along a fluid flow path of a compressor when a refrigerant is flowing in a normal direction of flow according to an embodiment;

FIG. 5B is a schematic diagram of the plurality of flow interference elements of FIG. 5A when a refrigerant is flowing in a backwards direction of flow according to an embodiment; and

FIG. 6 is a perspective view of an exemplary plurality of flow interference elements according to an embodiment.

### DETAILED DESCRIPTION

A detailed description of one or more embodiments of the disclosed apparatus and method are presented herein by way of exemplification and not limitation with reference to the Figures.

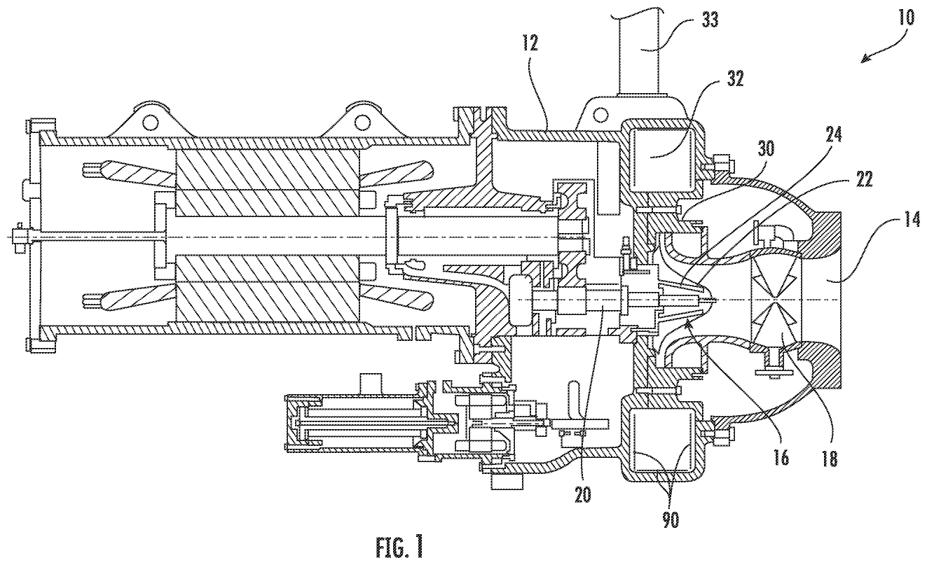

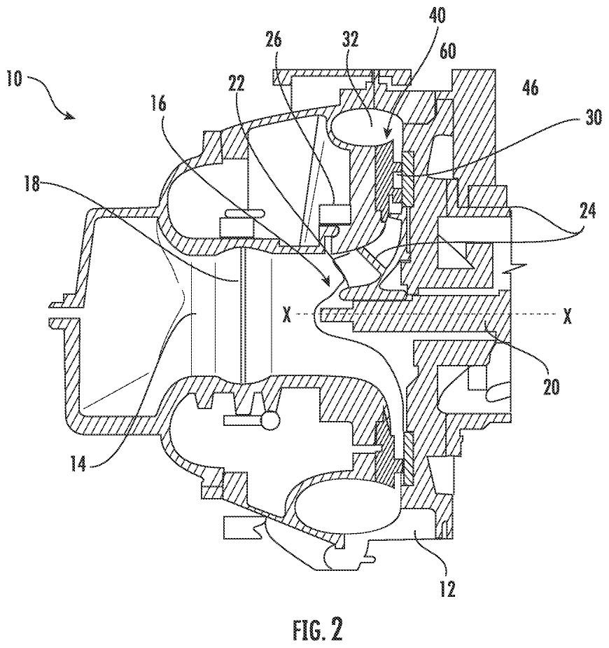

Referring now to FIG. 1, an example of a centrifugal compressor 10, such as commonly used in a refrigeration system is illustrated. As shown, the centrifugal compressor 10 includes a compressor housing 12 having an inlet or suction port 14 that directs refrigerant into a rotating impeller 16 through a series of adjustable inlet guide vanes 18. The impeller 16 is secured to a drive shaft 20 by any suitable means to align impeller 16 along the axis of the compressor 10. The impeller 16 includes central hub 22 supporting a plurality of blades 24. A plurality of passages 26 (best shown in FIG. 2) defined between adjacent blades 24 cause the incoming axial flow of a refrigerant fluid to turn in a radial direction and discharge the compressed refrigerant fluid from respective passages into an adjacent diffuser section 30. The diffuser section 30 is generally circumferentially disposed about the impeller 16 and functions to direct the compressed refrigerant fluid into a volute 32, wiich directs the compressed fluid toward a compressor outlet or discharge port, or alternatively, toward a second stage of the compressor 10, depending on the configuration of the compressor 10. When the compressor 10 is installed within a refrigeration system, a discharge pipe, illustrated at 33, extends from the discharge port of the compressor 10 to a downstream component of the refrigeration system, such as a condenser for example.

With reference now to the detailed view of a compressor shown in FIG. 2, in an embodiment, the diffuser section 30 includes a disc-like diffuser structure 40. The diffuser structure 40 may be a separate component mounted within the compressor housing, or alternatively, may be integrally formed with the compressor 10. Further, the diffuser structure 40 may be rotationally fixed or may be configured to rotate about the axis X. In embodiments where the diffuser structure 40 is rotatable, conventional mechanisms for mounting the diffuser structure 40 within the compressor 10 are contemplated herein.

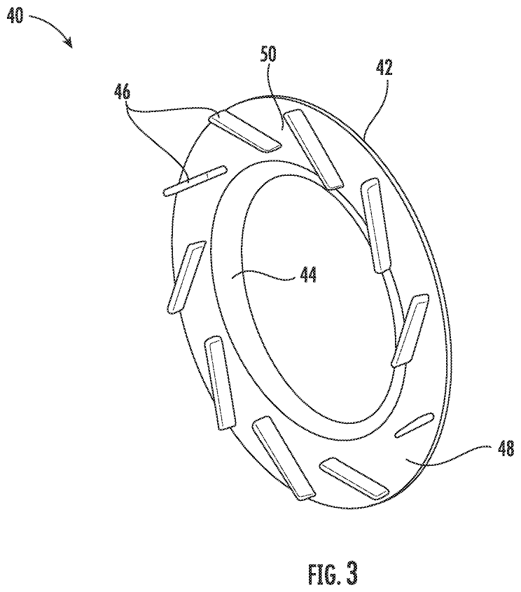

The diffuser structure 40 includes an outer edge 42 and an inner edge 44, the outer edge closely surrounding the impeller 16, such that refrigerant may be discharged from the impeller 16 to the diffuser structure 40. The diffuser structure 40 may have a generally planar configuration, or in some embodiments, may include a plurality of circumferentially spaced, fixed vanes 46, extending from a first, generally planar surface 48 thereof, as shown in FIG. 3. In such embodiments, the plurality of vanes 46 may be substantially identical, or alternatively, may vary in size, shape, and/or orientation relative to a central axis X of the compressor 10. As the refrigerant passes through the passageways 50 defined between adjacent vanes 46 of the diffuser structure 40, the kinetic energy of the refrigerant may be converted to a potential energy or static pressure. It should be understood that the diffuser structure 40 illustrated and described herein is intended as an example only and that other types of diffuser structures 40, such as a pipe diffuser or a channel type diffuser having one or more passages formed within the disc-like diffuser structure and arranged in fluid communication with the passages 26 of the impeller 16 are also contemplated herein.

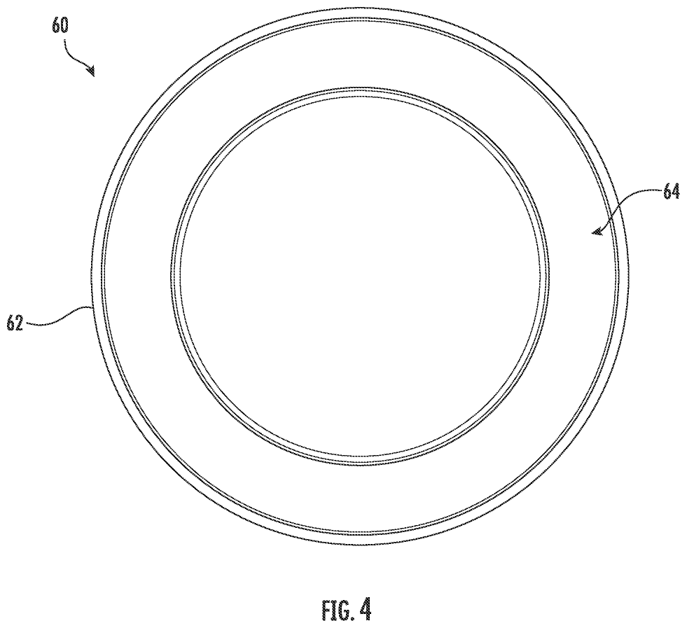

With continued reference to FIG. 2, alternatively, or in addition to the diffuser structure 40, the compressor 10 may include a silencer 60. The silencer 60 may be mounted to a surface of the compressor housing 12 facing the diffuser section 30, or alternatively, may be positioned within a circumferential groove (not shown) formed in the compressor housing 12. An example of a silencer 60 is illustrated in more detail in FIG. 4. The silencer 60 includes an annular housing 62 defining a cavity and a silencing pad 64 arranged within the cavity. In an embodiment, the inner diameter of the silencer 60 may be generally equal to the inner diameter of the diffuser structure 40, and an outer diameter of the silencer 60 may be generally equal to or slightly greater than the outer diameter of the diffuser structure 40. The silencing pad 64 is configured to absorb sound and reduce the noise of the compressor 60. The body of the silencing pad 64 may be formed from any suitable material including a metal, plastic, composite, or sound absorbing material. Examples of suitable sound absorbing materials, include but are not limited to glass fiber (e.g., compressed batting), polymeric material such as fiber, foam, or expanded bead material (e.g., porous expanded polypropylene (PEPP)), and combinations thereof for example. In an embodiment, in order to improve the noise reduction effect, the silencing pad 64 may include a plurality of layers of sound absorbing material, thereby providing a better sound absorbing effect.

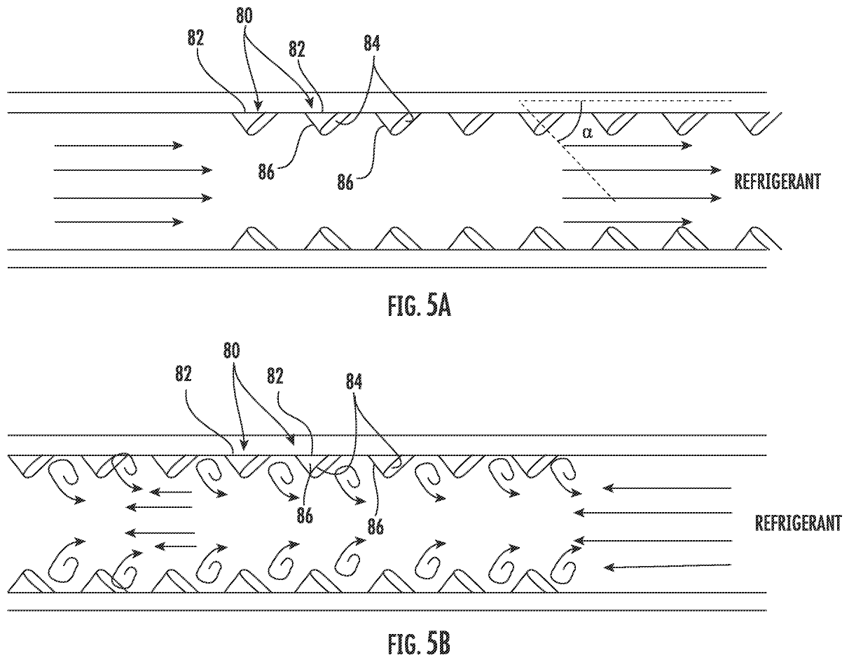

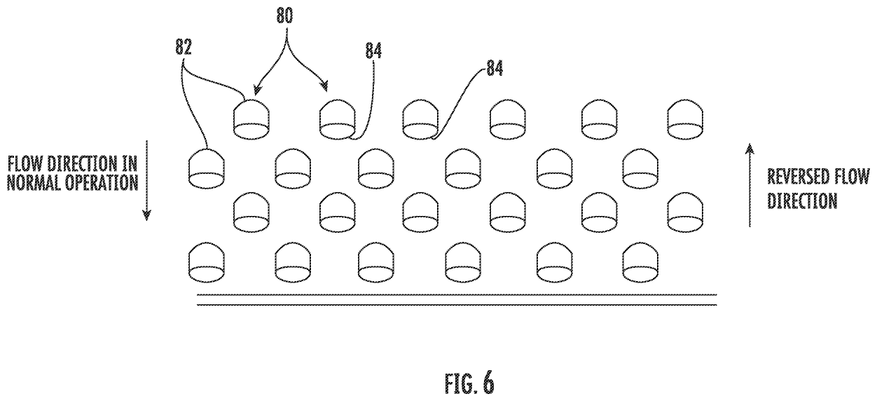

In the event of a compressor surge or sudden shutdown, the refrigerant vapor that has been exhausted from the outlet of the compressor may begin to flow backward into the compressor. To restrict this backwards flow, one or more flow interference elements 80 may be formed at one or more locations of the compressor 10. With reference to FIGS. 5A, 5B, and 6, an example of a group of flow interference elements 80 is illustrated in more detail. In the illustrated, non-limiting embodiment, a plurality of flow interference elements 80 are arranged at one or more locations or areas along the fluid flow path through the compressor 10. The plurality of flow interference elements 80 may be spaced at even or varying intervals extending in a direction parallel to the direction of flow and/or in a direction extending away from the direction of flow, such as across the width of the flow path, perpendicular to the direction of flow for example. Further, in embodiments where the flow interference elements 80 extend both parallel to the direction of flow and away from the direction of flow, one or more flow interference elements 80 that are located downstream from another one or more flow interference elements 80 may be aligned with and/or may be staggered relative to the one or more upstream flow interference elements 80. Although the flow interference elements 80 are illustrated and described herein as being arranged within a group, it should be understood that embodiments having only a single flow interference element 80 arranged at a specific area or location of the compressor 10 are also contemplated herein.

As shown in FIG. 5A, during normal operation of the compressor 10, the refrigerant is configured to flow through the fluid flow path of the compressor 10 in a first, forward or normal direction of flow. Each of the plurality of flow interference elements 80 is connected at a first end 82 to a surface of a portion of the compressor 10 and extends into the fluid flow path of the compressor 10. In the illustrated, non-limiting embodiment, the flow interference elements 80 are generally cylindrical in shape and have a substantially planar distal end 84. However, it should be understood that embodiments where the flow interference elements 80 have another shape or cross-sectional shape, such as rectangular or triangular for example, and/or where the distal end 84 has a non-planar configuration are also within the scope of the disclosure. Further, in an embodiment, the size of the flow interference elements 80 in each dimension may be up to 5% of the equivalent internal diameter of the corresponding area of the compressor. The equivalent internal diameter may be based on the cross-sectional area of the compressor at the location of the flow interference elements 80.

In an embodiment, one or more of the plurality of flow interference elements 80 are oriented at an non-zero angle α (See FIG. 5A) relative to the direction of flow such that the distal or free end 84 arranged within the fluid flow path is located downstream from the first, mounting end 82 of the flow interference element 80. As a result of this angle, when the refrigerant is moving through the compressor 10 in the first direction (FIG. 5A), only a smooth, curved or rounded side surface 86 of the flow interference elements 80 is configured to interact with the refrigerant flow. In an embodiment, the shape of the body or side surface 86 of the flow interference element 80 is selected to minimize interference with a refrigerant flow moving the in the first, normal direction. However, when the refrigerant is moving through the compressor 10 in a backwards direction of flow (FIG. 5B), the distal end 84 is arranged directly within the fluid flow path, and therefore is configured to interact with the refrigerant flow. As shown, the distal end 84 is arranged at a non-parallel angle to the refrigerant flow such that the substantially entire surface of the distal end 84 is configured to interact with the backwards flow. As the backwards flow contacts the surface of the distal ends 84 of the flow interference elements 80, turbulence, such as a large scale disturbance in the form of vortices for example, is generated within the refrigerant flow. As these vortices interact with the backwards flow, the backwards refrigerant flow is severely hindered, thereby reducing the amount of refrigerant flow downstream from the flow interference elements 80 in the backwards or reverse direction of flow.

In embodiments where the flow interference elements 80 are arranged in a group, the configuration of the flow interference elements 80 within the group, such as the shape, length and angle for example, may be substantially identical, or alternatively may vary, for example based on the specific location of the flow interference elements 80. Further, as previously noted, one or more flow interference elements may be arranged at one or more locations along the fluid flow path through the compressor 10 and/or the refrigeration system. Examples of suitable locations include, but are not limited to, within the volute, the diffuser section, and the discharge pipe. Further, in an embodiment, one or more flow interference elements are arranged downstream from the compressor 10 within a refrigeration system, such as within the discharge pipe 33 connecting the compressor 10 to a condenser for example. In embodiments where one or more flow interference elements 80 are located at a plurality of distinct locations along the fluid flow path, the configuration of the flow interference elements 80 at each distinct location may be the same, or alternatively, may vary.

In an embodiment, one or more flow interference elements 80 are integrally formed with a component of the compressor 10. For example, within the diffuser section 30, one or more flow interference elements 80 may be integrally formed with the silencing pad 64 of the silencer 60 and/or with the surface 48 of the diffuser structure 40. Alternatively, or in addition, one or more flow interference elements 80 may be integrally formed with an inner surface of the compressor housing 12, such as a surface defining the volute 32 or the discharge pipe for example. Alternatively, or in addition, one or more flow interference elements 80 may be formed in a separate component, such as a plate for example, that is mountable within the compressor 10 along the fluid flow path. In the illustrated, non-limiting embodiment of FIG. 1, one or more plates 90 may be arranged within the interior of the volute 32, and at least one of the one or more plates may have a plurality of flow interference elements 80 formed therein.

Inclusion of a plurality of flow interference elements arranged along the fluid flow path of a compressor 10 impedes the backwards flow of refrigerant through the compressor 10. Accordingly, the flow interference elements 80 as described herein form a passive flow control device that has increased reliability and simplicity relative to active flow control devices, such as check valves for example. In addition, this reduction of the backwards flow through the compressor 10 increases the life span of the moving components of the compressor 10, such as the rotors and the bearings.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A compressor comprising:
a housing having an inlet and an outlet and a fluid flow path extending between the inlet and the outlet;
an impeller mounted within the housing, the impeller being movable to move a fluid from the inlet along the fluid flow path to the outlet; and
a plurality of flow interference elements arranged within the housing at one or more locations along the fluid flow path, wherein when a fluid flows through the fluid flow path in a backwards direction of flow, a disturbance is generated in the fluid adjacent each of the plurality of flow interference elements.

2. The compressor of claim 1, wherein the plurality of flow interference elements arranged within the housing at the one or more locations along the fluid flow path are substantially identical.

3. The compressor of claim 1, wherein the plurality of flow interference elements arranged within the housing at the one or more locations along the fluid flow path are spaced in a direction parallel to a direction of flow of the fluid flow path.

4. The compressor of claim 1, wherein the plurality of flow interference elements arranged within the housing at the one or more locations along the fluid flow path are spaced in a direction away from a direction of flow of the fluid flow path.

5. The compressor of claim 1, wherein at least one of the plurality of flow interference elements extends at an angle relative to the fluid flow path.

6. The compressor of claim 1, wherein a distal end of each of the plurality of flow interference elements is arranged at a non-zero angle relative to the fluid moving in the backwards direction of flow through the fluid flow path.

7. The compressor of claim 1, further comprising a diffuser section within the housing downstream from the impeller along the fluid flow path, wherein a portion of the plurality of flow interference elements are located at the diffuser section.

8. The compressor of claim 7, wherein the diffuser section includes a diffuser structure and the portion of the plurality of flow interference elements are formed in the diffuser structure.

9. The compressor of claim 7, wherein the diffuser section includes a silencer and the portion of the plurality of flow interference elements are formed in the silencer.

10. The compressor of claim 1, further comprising a volute formed within the housing downstream from the impeller along the fluid flow path, wherein a portion of the plurality of flow interference elements are located within the volute.

11. The compressor of claim 10, wherein the portion of the plurality of flow interference elements located within the volute are integrally formed with the housing.

12. The compressor of claim 10, further comprising a plate positioned within the volute, wherein the portion of the plurality of flow interference elements located within the volute are formed in the plate.

13. The compressor of claim 1, wherein a portion of the plurality of flow interference elements are integrally formed with the housing.

14. The compressor of claim 1, wherein the one or more locations includes a plurality of distinct locations.

15. The compressor of claim 14, wherein a configuration of the plurality of flow interference elements varies between each of the plurality of distinct locations.

16. The compressor of claim 1, wherein the compressor is part of a refrigeration system.
